(19) United States
(12) Patent Application Publication
(10) Pub. No.: US 2018/0374647 A1
(43) Pub. Date: Dec. 27, 2018

(54) PULSED METALLIZED FILM CAPACITOR

(71) Applicant: SCIENTIFIC APPLICATIONS & RESEARCH ASSOCIATES, INC., CYPRESS, CA (US)

(72) Inventors: CAMERON HETTLER, CYPRESS, CA (US); SCOTT A. ELDRIDGE, CYPRESS, CA (US); NATHAN ZAMEROSKI, CYPRESS, CA (US); THOMAS J. EDWARDS, CYPRESS, CA (US); MICHAEL S. SPENCER, CYPRESS, CA (US)

(73) Assignee: SCIENTIFIC APPLICATIONS & RESEARCH ASSOCIATES, INC., CYPRESS, CA (US)

(21) Appl. No.: 16/020,503

(22) Filed: Jun. 27, 2018

Related U.S. Application Data
(60) Provisional application No. 62/525,690, filed on Jun. 27, 2017.

(51) Int. Cl. H01G 4/33; H01G 4/018; H01G 4/232

(52) U.S. Cl. CPC H01G 4/33; H01G 4/232; H01G 4/018

(57) ABSTRACT

A novel metallized film capacitor is contemplated. The capacitor includes a first film and a second film. Each of the first film and second film have a metallized layer added. Each of the metallized layers includes alternating metallized sections and margin sections. The outermost sections on one film are metallized sections, while the outermost sections on the other film are margin sections. This pattern and proper sizing of the sections creates overlap regions where a metallized section from one film overlaps a metallized section from the other film. These overlap regions create sub-capacitors that give the capacitor low inductance while allowing for high current and high voltage.

### CROSS-REFERENCE TO RELATED APPLICATIONS

This application claims priority to U.S. Provisional Patent Application No. 62/525,690, filed Jun. 27, 2017.

### STATEMENT RE: FEDERALLY SPONSORED RESEARCH/DEVELOPMENT

Not Applicable

### BACKGROUND

The present invention relates to capacitors, and in particular metallized film capacitors and methods of fabricating the same.

State of the art high voltage pulse power capacitors typically used for fast discharge, high peak current (>0.3 kA/cm²), high voltage (>5 kV/cm), and low inductance (<0.1-1 nH/kV) applications are constructed out of oil impregnated plastic, paper, and metal foil. Oil provides high voltage insulation for the high electric field strengths generated between conductors and metal foil which provides high discharge current capability.

Although the oil impregnated plastic, paper, and metal foil capacitors offer a solution for high voltage and high peak current pulse applications, they also suffer from a number of shortcomings. For example, the energy density of oil impregnated plastic, paper, and metal foil is low and typically <0.1 J/cc (cubic centimeter). This low energy density requires the oil impregnated capacitors to be bulker and heavier than would be preferred. Moreover, the voltage hold off margins of these oil impregnated capacitors further contribute to a larger size than would be preferred. As the inductance is determined by the physical size of the capacitor, it is difficult to reduce for high voltage capacitors (>75 kV) of this construction. Finally, oil/film capacitors are not self-healing, and as such dielectric breakdowns or short circuits between the electrodes necessarily lead to the destruction of the component.

Another drawback is that the oil/film capacitors cannot be used at temperatures less than approximately −10° C., depending on the precise oil used, because the oil starts to solidify and gel and consequently loses its voltage hold off or insulating capabilities.

Thus, there is an industry need for a lighter, smaller, lower inductance capacitor that can operate across a broader range of temperatures to provide power to the next generation of pulsed power systems. There is likewise a need in the art for a method of manufacturing such capacitors that enables the same to be effectively and efficiently manufactured in a reliable manner and operative to retain its desired properties.

### BRIEF SUMMARY

The present disclosure specifically addresses and alleviates the above-identified deficiencies in the art. In this regard, post metallized film capacitors and methods of manufacturing the same are herein contemplated. According to a preferred embodiment, of a post metallized film capacitor, the capacitor comprises the combination of first and second films, the first film including a first dielectric and a first metallized layer, the first metallized layer including a first set of alternating metallized sections and margin sections. The second film is narrower than the first film and includes a second dielectric and a second metallized layer, wherein the second metallized layer includes a second set of alternating metallized sections and margin sections. The first and second films are in alignment with one another such that the first dielectric of the first layer is positioned between the first metallized layer and the second metallized layer. Moreover, the first film extends beyond two of the opposing sides of the second film, and at least one of the metallized sections of the second metallized layer overlaps two of the metallized sections and one of the margin section of the first metallized layer. According to an additional refinement of this embodiment, the first film may be approximately 2 mm wider than the second film, and the outermost sections of the first set of alternating metallized sections and margin sections may be either metallized sections or margin sections (i.e. portions on the film that may not contain metal or may be substantially less conductive than the metallized section). It is further contemplated that, the first film may have a resistance of 5Ω/□ and the second film may have a resistance of 15Ω/□ and that the post metallized film capacitor may have an inductance of less than 80 nH, with additional potential modifications of construction and implementation being further envisioned herein.

With respect to methods of fabricating a post metallized film capacitor of the present disclosure, such process may comprise of the steps of coating a first film with a first metallized layer, wherein the first metallized layer includes a first set of alternating metallized sections and margin sections, the first film including a first dielectric, and coating a second film with a second metallized layer, the second metallized layer including a second set of alternating metallized sections and margin sections, the second film also including a second dielectric. The first and second films are then positioned in alignment to one another such that the first dielectric is between the first metallized layer and the second metallized layer, and at least one metallized section of the first set of alternating metallized sections and margin sections, overlaps with two metallized sections on the second metallized layer, and at least one metallized section of the second set of alternating metallized sections and margin sections overlap with two metallized sections on the first metallized layer.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a perspective view of a capacitor according to an embodiment of the present disclosure;

FIG. 2A shows a schematic side view of a first film according to an embodiment of the presently disclosed capacitor;

FIG. 2B shows a schematic side view of a second film according to an embodiment of the presently disclosed capacitor;

FIG. 3 shows a schematic view of an embodiment of the combined first film and second film;

FIG. 4A shows a schematic view of current flow in prior art capacitors; and

FIG. 4B shows a schematic view of current flow according to an embodiment of the presently disclosed capacitor.

### DETAILED DESCRIPTION

The detailed description set forth below is intended as a description of a presently preferred embodiment of the contemplated capacitor, and is not intended to represent the only form in which the presently disclosed concepts may be implemented or performed. The description also sets forth certain functions and sequences of steps for practicing certain herein contemplated concepts. It is to be understood, however, that the same or equivalent functions and sequences may be accomplished by different embodiments, and that those functions and sequences are also intended to be encompassed within the scope of the present disclosure.

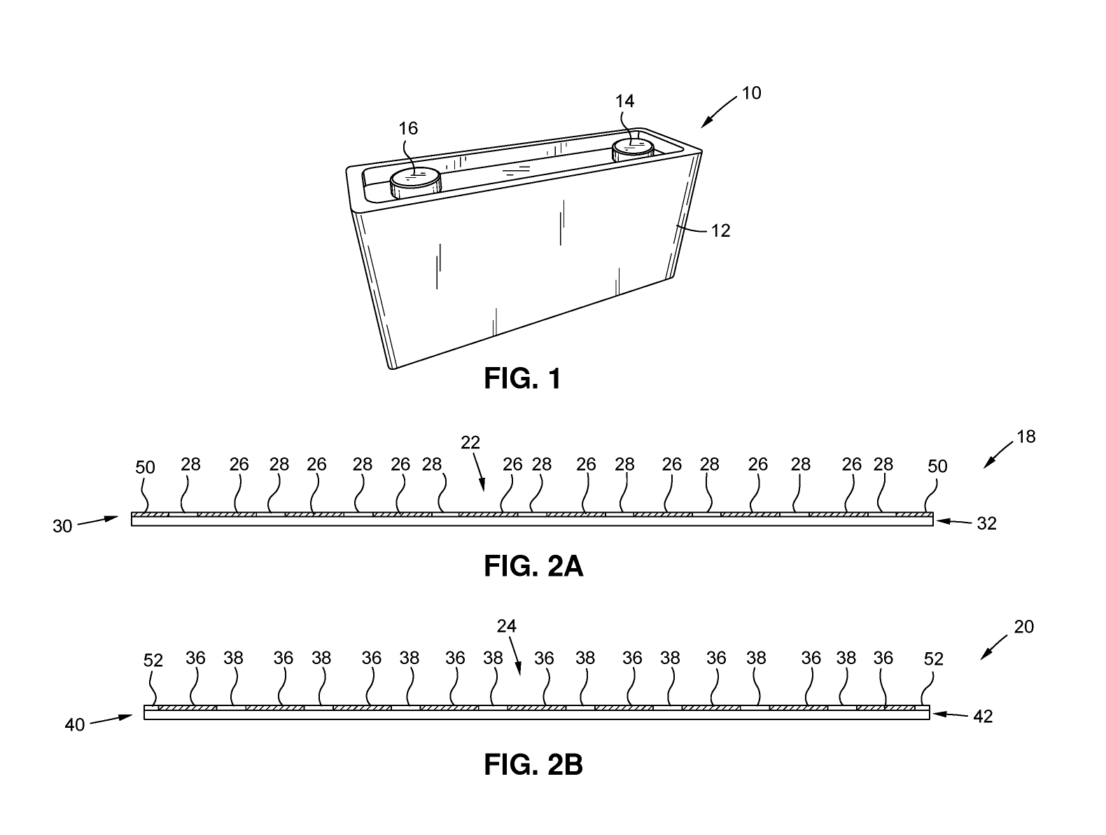

Referring now to the drawings, and initially to FIG. 1, an exemplary pulsed metallized film capacitor 10 is illustrated. The illustrated exemplary capacitor 10 is a hybrid technology that combines the high energy density, low inductance, and safety of traditional metallized film capacitors (mfc) with the high voltage and high current capabilities of traditional oil-filled foil film capacitors. Advantageously, pulse metallized thin film capacitors do not suffer from the previously discussed operating temperature range problem, as they are oil free. This unique feature permits pulse metallized thin film capacitors to operate, dielectric dependent, from −50° C. to 200° C.

The disclosed capacitor design takes advantage of the compact nature of thin metallized films without any impregnated oil, and in turn is operative to provide high voltage, high current, and fast discharge performance. The key enabling feature to achieve that end is the construction of many series capacitors within a single capacitor, also called a winding. The construction of the many series capacitors is accomplished by offsetting a metallization pattern on two pieces of dielectric film and then combining the two pieces of dielectric film. This method allows the electric field to be graded over the length of the capacitor from one side to the other, thus increasing the voltage rating (also known as voltage hold off) capabilities of the capacitor while carrying high current.

In the exemplary capacitor 10 shown in FIG. 1, the capacitor 10 includes a housing 12, a first electrode 14, and a second electrode 16. Internally, the capacitor 10 includes windings of material which are connected to the electrodes. As discussed in detail below, the inductance of a capacitor 10 depends on two primary factors. First, the inductance of a capacitor 10 depends on the physical dimensions of the capacitor 10. Specifically, the inductance may depend on a combination of various aspects of its physical dimensions, such as the Length×Width×Height volume of the package of the capacitor, the rail geometry, and the location. The inductance may also depend on the arrangement of current carrying conductors, also known in the art as windings, in the capacitor 10.

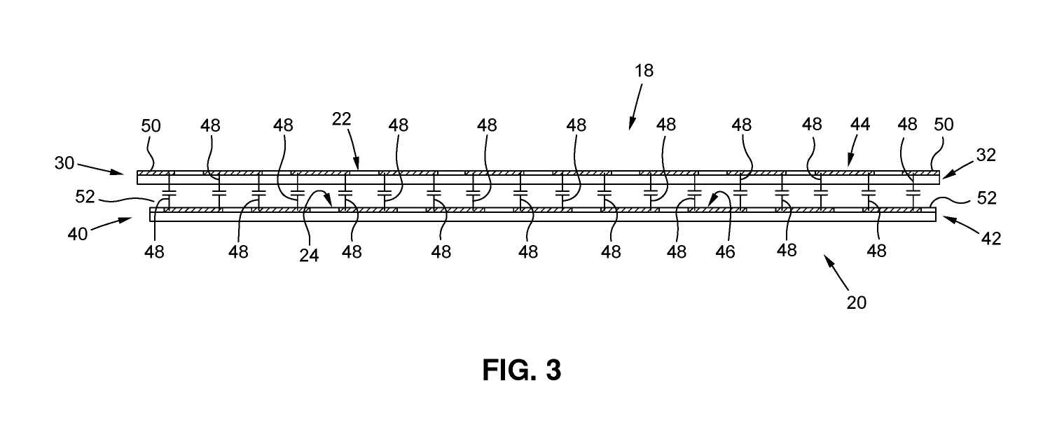

Certain embodiments of the disclosed metallized film portions of a capacitor 10 are shown in FIGS. 2A, 2B, and 3. These embodiments may include a first film 18 and a second film 20 with the first film and the second film may be made of a dielectric material. In the exemplary embodiments, the dielectric material is polypropylene. However, it may be seen that in other embodiments, other dielectric materials may be utilized. Each of the first film 18 and the second film 20 may have a thickness of in the range of 2-20 μm. Both the first film 18 and the second film 20 may be coated with dedicated metallized layers, wherein first film 18 is coated with a first metallized layer 22 and the second film 20 is coated with second metallized layer 24. These metallized layers, which may be fabricated from, among other metallic materials, aluminum, zinc, nickel or chromium, may be formed by depositing such materials upon the first and second films 18, 20, and allowing each dedicated metallized layer 22, 24 to condense thereon, respectively, in a vacuum. However, it may be seen that other methods of fabricating a metallized layer other than vacuum deposition may be utilized without departing from the scope and spirit of the present disclosure. Further, it may be seen that other methods of manufacturing the herein discussed metallized films may be utilized, including of fabrication wherein the individual metallized films may not necessarily be fabricated individually and subsequently placed into alignment during an assembly step, but rather may be jointly fabricated in a unitary step or sequence of steps, such as in an additive manufacturing process.

As shown in FIG. 2A, the first film 18 may be fabricated to have a width in the range of 50-200 mm, and preferably in the range of 90-120 mm, with 110-112 mm being most preferred. The thickness of the first metallized layer 22, may be in the range of 0.01-1 μm, and preferably in the range of 0.02-0.5 μm, with 0.03-0.2 μm being most preferred. The first metallized layer 22 may be formed in a pattern that may include metallized sections 26 alternating with margin sections 28. The metallized sections 26 may have a width in the range of 1-50 mm, and preferably in the range of 4-20 mm, with 6-16 mm being most preferred. The margin sections 28 may have a width in the range of 1-45 mm, and preferably in the range of 1-10 mm, with 1-3 mm being most preferred. The outermost sections, that is, the sections on a first side 30 and a second side 32, of the first film 18 may be metallized sections 26 with those outer most metallized sections 26 may have a width in the range of 2-12 mm, and preferably in the range of 3-9 mm, with 4-6 mm being most preferred. The resistivity of the first film 18, which also may be called a sheet, may be measured in ohms per square (Ω/□). The resistivity of the first film 18 may be in the range of 1-10Ω/□, and preferably in the range of 3-8Ω/□, and with 4-6Ω/□ being most preferred.

As shown in FIG. 2B, the second film 20 may have a width in the range of 25-150 mm, and preferably in the range of 90-120 mm, with 105-108 mm being most preferred. The thickness of the second metallized layer 24, may be in the range of 0.1-1 μm, and preferably in the range of 0.3-0.7 μm, with 0.4-0.6 μm being most preferred. Similar to the first metallized layer 22, the second metallized section 26 of the second film 20 may be formed in a pattern that may include metallized sections 36 alternating with margin sections 38. The metallized sections 36 may have a width in the range of 5-20 mm, and preferably in the range of 6-12 mm, with 7-9 mm being most preferred. The margin sections 38 may have a width in the range of 1-12 mm, and preferably in the range of 2-8 mm, with 3-5 mm being most preferred. The outermost sections, that is, the sections on a first side 40 and a second side 42, of the second film 20 may be margin sections 38, and the outermost margin sections 38 may have a width in the range of 1-8 mm, and preferably in the range of 1-5 mm, with 1-3 mm being most preferred. The resistivity of the second film 20 may be in the range of 1-50Ω/□, and preferably in the range of 10-25Ω/□, and with 10-25Ω/□ being most preferred.

After the first metallized layer 22 is placed on the first film 18 and second metallized layer 24 is placed on the second film 20, the first film 18 and the second film 20 may then be placed in alignment, as is shown schematically in FIG. 3. The first film 18 and second film 20 may be placed in alignment so that the dielectric material of the first film 18 is located between the first metallized layer 22 and the second metallized layer 24. Additionally, the first film 18 and second film 20 may be rolled together into a cylindrical winding. Once rolled, the first film 18 and second film 20 may be left cylindrical or the first film 18 and second film 20 may be flattened to fit in to an oval, cubic, or parallelepiped housing.

As can be seen in FIG. 3, the metallized sections 26 (FIG. 2A) and margin sections 28 (FIG. 2A) of the first metallized layer 22 may form a first set 44 of alternating metallized sections 26 and margin sections 28, and the metallized sections 36 (FIG. 2B) and margin sections 38 (FIG. 2B) of the second metallized layer 24 may form a second set 46 of alternating metallized sections 36 and margin sections 38. When the first film 18 and second film 20 are placed in alignment, the metallized sections 26, 36 of the first set 44 and second set 46 may form an generally overlapping pattern where one of the metallized sections 26 of the first set 44 may at least partially overlap two metallized sections 36 of the second set 46 and one of the metallized sections 36 of the second seet 46 may at least partially overlap two metallized sections 26 of the first set 44. Each area of overlap may be called an overlap region. At each overlap region, a sub-capacitor 48 is thus created. The capacitor 10 may, in the exemplary embodiment, include a series of eighteen sub-capacitors 48 when the first film 18 and the second film 20 are configured as illustrated in FIGS. 2A and 2B and are placed in alignment in the pattern as shown in FIG. 3. However, in other embodiments, it may be seen that the first film 18 and the second film 20 may be configured in a variety of ways, and may be placed in alignment in a variety of ways, such that the capacitor 10 may include a series of less than or more than eighteen sub-capacitors 48.

The first film 18 in the illustrated exemplary embodiment is also shown being wider than the second film 20 and may thus extend beyond two opposing sides 40, 42 of the second film 20. The outermost sections of the first set 44 may be metallized sections 26 and may also be a different size than the other metallized sections 26 formed on the first film 18. As illustrated, the outermost metallized sections, shown as 50, may be narrower than the other metallized sections 26. For example, the outermost sections 50 may be 5 mm, or half the size of the other metallized sections 26 plus an extra millimeter for the additional width of the first film 18 as compared to the second film 20, as described above. However, other dimensional arrangements are possible as well.

Likewise, the outmost sections 52 of the second set 46 of alternating metallized sections 36 and margin sections 38 may be margin sections and may be a different size than the other margin sections 38. For example, the outermost sections 52 may be 2 mm, or half the size of the other margin sections 38 of the second set 46. The differing size of outermost sections 50, 52 can thus help create the proper offset for the alternating metallized sections 26, 36 and margin sections 28, 38 in each of the first set 44 and second set 46.

The capacitance of each of the sub-capacitors 48 in the series metallization pattern is determined by the film thickness, permittivity of the dielectric ε_{R}, and area overlap of the metallization patterns of the first film 18 and the second film 20. In the exemplary embodiment described above, the eighteen series metallization pattern creates eighteen sub-capacitors in series that grade the applied voltage. The number of sub-capacitors in the created by the metallization pattern can be increased or decreased, depending on the capacitor requirements. As will be appreciated by those skilled in the art, the metallization pattern may be critical for optimizing the voltage grading and hold off across the capacitor 10, while optimizing capacitance. This novel metallization pattern can range from 1-10 series capacitors per cm of winding length, and preferably may range from 1-5 series sub-capacitors per cm of winding length. The eighteen series pattern in FIG. 2 represents 1.64 series sub-capacitors per centimeter.

Because of this metallization pattern, the capacitor 10 is advantageously much smaller than oil filled capacitors of the same voltage rating, current rating, and capacitance value. The small physical size of the capacitors 10 of the present disclosure means that the capacitors 10 of the present disclosure have less internal inductance when compared to oil filled capacitors. Further, the capacitors 10 of the present disclosure have a higher energy density than the state of the art oil impregnated capacitors. Still further, the capacitors 10 of the present disclosure are physical smaller than their oil impregnated counterparts.

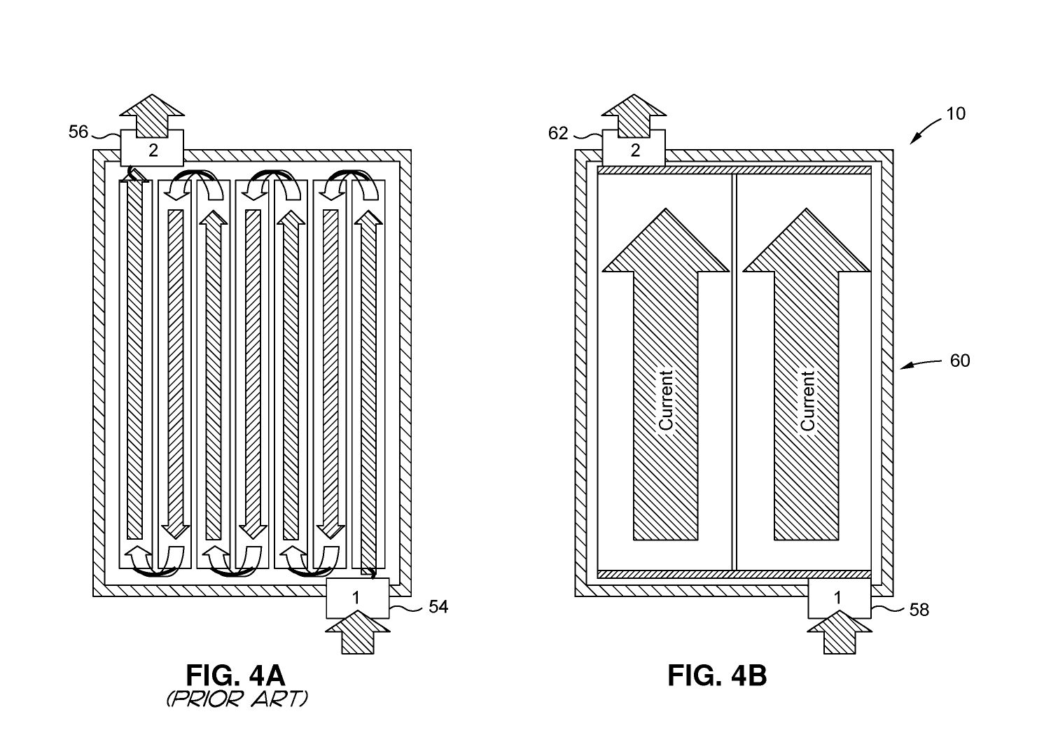

Referring to FIG. 4A, there is shown arrows to indicate the path of current through a traditional low-inductance oil filled capacitor. The current flows in to a first terminal 54 at the lower right corner and travels in a serpentine manner indicated by the arrows through the seven series windings before exiting at a second terminal 56. The close spacing and stacked winding of the traditional low-inductance oil filled capacitor configuration greatly reduces the circuit inductance through flux cancellation but the overall current path is still quite long. With this traditional oil filled construction method, the charge stored in the first winding closest to a first terminal 54 has a long physical distance to travel before exiting at a second terminal 56.

In contrast, as shown in FIG. 4B, the construction technique of embodiments of the present disclosure may be seen to reduce the current path length and overall inductance compared to traditional foil capacitors. The disclosed capacitors 10 may be constructed with pulsed metallized film capacitor (PMFC) technology, as described above, whereby the capacitor windings are stacked directly on top of each other and the current does not necessarily navigate through serpentine “windings” like in prior art capacitors. FIG. 4B shows the paths of current flow through one embodiment of a capacitor 10 according to the present disclosure. The current enters through a first terminal 58 and divides evenly throughout the cross-section 60 of the capacitor and converges again at a second terminal 62. In this configuration, the capacitor inductance is reduced to levels that may be essentially equivalent to a solid conductor of the same package dimensions. The disclosed pulsed metallized film capacitor design thus may advantageously result in a capacitor 10 with lower inductance than equivalent oil based capacitors.

A metallized film capacitor 10 may be implemented in a number of self-healing form factors. For purposes of this disclosure, the term self-healing means that dielectric breakdowns or short circuits between the electrodes do not necessarily lead to the destruction of the component. The disclosed embodiments of the pulsed metallized film capacitor 10 may have form factors which are cubical, cylindrical, or parallelepiped. According to a first exemplary embodiment, the pulsed metallized film capacitor 10 may have a voltage in the range of 50 kV to 200 kV, and preferably in the range of 75-125 kV, and most preferably 90-110 kV. This first exemplary embodiment may have a current in the range of 15-50 kA, and preferably in the range of 20-40 kA, and most preferably in the range of 25-35 kA. This first exemplary embodiment may have a capacitance in the range of 10-100 nF, and preferably in the range of 20-50 nF, and most preferably in the range of 25-35 nF. This first exemplary embodiment may have an inductance of less than 80 nH, depending on the implementation of the capacitor. The energy density of this first exemplary embodiment may be in the range of 0.1-1 J/cc, and preferably in the range of 0.15-0.5 J/cc, and most preferably 0.2-0.4 J/cc. The form factor of this first exemplary embodiment may have a length in the range of 6-12 inches long, and preferably in the range of 8-12 inches long, and most preferably in the range of 9-10 inches long. The package diameter of this first exemplary embodiment may be in the range of 1-6 inches, and more preferably in the range of 2-4.5 inches, and most preferably in the range of 2-3 inches.

A second exemplary embodiment of the metallized film capacitor 10 is also contemplated, and may have a voltage in the range of 50 kV to 200 kV, and preferably in the range of 75-125 kV, and most preferably 90-110 kV. This second exemplary embodiment may have a current in the range of 50-250 kA, and preferably in the range of 100-200 kA, and most preferably in the range of 125-175 kA. This second exemplary embodiment may have a capacitance in the range of 50-500 nF, and preferably in the range of 100-4000 nF, and most preferably in the range of 225-275 nF. This second exemplary embodiment of the metallized film capacitor 10 may have an inductance of less than 40 nH, depending on the implementation of the capacitor. The energy density of this second exemplary embodiment of the metallized film capacitor 10 may be in the range of 0.1-1 J/cc, and preferably in the range of 0.25-0.75 J/cc, and most preferably 0.4-0.6 J/cc. This second exemplary embodiment may have a form factor with a width in the range of 1-8 inches, and preferably in the range of 2-6 inches, and most preferably in the range of 3-5 inches, and with a length in the range of 3-15 inches, and preferably in the range of 6-12 inches, and most preferably in the range of 8-10 inches.

It may be seen by these different embodiments that one important aspect of the herein contemplated capacitors 10 is that by controlling various parameters of the metallization patterns during fabrication of the films, such as the width of the various metal and margin sections, the size of overlap regions, and the periodicity of the metal and margin sections, the resulting capacitor 10 may be customized in various ways which may optimize certain desired traits for a specific application. For example, control of such various parameters may result in changes in voltage, current, discharge speed, or energy densities, all of which may be higher or lower than conventional oil-based capacitors. Embodiments are contemplated, for example, where the periodicity of the metal and margins sections on a single given film, for example, may be as low as one or as high as in the hundreds, which may result in, among other things, the creation of different amounts of sub-capacitors. It may thus be seen that the presently contemplated capacitors, by permitting tuneability of the metallization patterns, may not only display better overall general performance than prior art capacitors, but also may be amenable to optimization for a specific desired application in a way in which prior capacitors are not.

The above description is given by way of example, and not limitation. Given the above disclosure, one skilled in the art could devise variations that are within the scope and spirit of the inventions disclosed herein, including various ways of sizing and ordering the metallized sections and margin sections placed on the first film and second film. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pulsed metallized film capacitor comprising:
a first film including a first dielectric, and a first metallized layer, the first metallized layer including a first set of alternating metallized sections and margin sections; and
a second film narrower than the first film, the second film including a second dielectric, and a second metallized layer, the second metallized layer including a second set of alternating metallized sections and margin section;
wherein the first film and second film are in alignment with the first dielectric between the first metallized layer and the second metallized layer, the first film extends beyond two opposing sides of the second film, and at least one of the metallized sections of the second metallized layer overlaps two metallized sections and one margin section of the first metallized layer.

2. The pulsed metallized film capacitor of claim 1, wherein the first film is two millimeters wider than the second film.

3. The pulsed metallized film capacitor of claim 1, wherein the outermost sections of the first set of alternating metallized sections and margin sections are metallized sections.

4. The pulsed metallized film capacitor of claim 3, wherein the outermost sections of the second set of alternating metallized sections and margin sections are margin sections.

5. The pulsed metallized film capacitor of claim 1, wherein the first film has a resistance of 5Ω/□.

6. The pulsed metallized film capacitor of claim 1, wherein the second film has a resistance of 15Ω/□.

7. The pulsed metallized film capacitor of claim 1, wherein the current flows directly from a first terminal attached to the first film and the second film to a second terminal attached to the first film and the second film.

8. The pulsed metallized film capacitor of claim 1, wherein the inductance of the pulsed metallized film capacitor is less than 80 nH.

9. The pulsed metallized film capacitor of claim 1, wherein at least one metallized section of the first set of alternating metallized sections and margin sections and at least one metallized section of the second set of alternating metallized section and margin sections overlaps with two metallized sections on the opposite metallized layer.

10. A method of forming a capacitor, the method comprising the steps of:
applying a first metallized layer to a first film, the first metallized layer including a first set of alternating metallized sections and margin sections, the first film including a first dielectric;
applying a second metallized layer to a second film, the second metallized layer including a second set of alternating metallized sections and margin section, the second film including a second dielectric; and
aligning the first film with the second film with the first dielectric between the first metallized layer and the second metallized layer, such that at least one metallized section of the first set of alternating metallized sections and margin sections overlaps with two metallized sections on the second metallized layer and at least one metallized section of the second set of alternating metallized sections and margin sections overlaps with two metallized sections on the first metallized layer.

11. The method of claim 10, wherein the first film is in alignment with the second film such the first film extends beyond two opposing sides of the second film.

12. The method of claim 10, wherein the outermost sections of the first set of alternating metallized sections and margin sections are metallized sections.

13. The method of claim 10, wherein the outermost sections of the second set of alternating metallized sections and margin section are margin sections.

14. The method of claim 10, wherein the inductance of the capacitor is less than 80 nH.

15. The method of claim 10, wherein the first film has a resistance of 5Ω/□.

16. The method of claim 10, wherein the second film has a resistance of 15Ω/□.

17. The method of claim 10, wherein no oil is added to the capacitor.
